(19) United States
(12) Patent Application Publication
(10) Pub. No.: US 2009/0154710 A1
(43) Pub. Date: Jun. 18, 2009

(54) Method for the Secure Deposition of Digital Data, Associated Method for Recovering Digital Data, Associated Devices for Implementing Methods, and System Comprising Said Devices

(75) Inventors: Eric Brier, Aubagne (FR); Mathieu Ciet, La Ciotat (FR)

Correspondence Address: BUCHANAN, INGERSOLL & ROONEY PC, POST OFFICE BOX 1404, ALEXANDRIA, VA, 22313-1404, US

(73) Assignee: GEMPLUS, GEMENOS (FR)

(21) Appl. No.: 12/084,301

(22) PCT Filed: Oct. 27, 2006
(86) PCT No.: PCT/EP2006/067897

§ 371 Date: Apr. 29, 2008

(30) Foreign Application Priority Data
Nov. 2, 2005 (FR) 0511124

(51) Int. Cl. H04L 9/32; H04L 9/00

(52) U.S. Cl. 380/286; 380/277

(57) ABSTRACT

The invention relates to a method for the secure deposition of data, according to which a depositor encrypts the data with a transfer key and encrypts the transfer key with a key of a third party, then deposits the encrypted data and the encrypted transfer key on a storage support. The invention also relates to a method for recovering data, during which an addressee of the data recovers the content of the storage support, authenticates him/herself to the third party, and transmits the encrypted transfer key thereto. After having authenticated the addressee, the third party returns the decrypted transfer key. The addressee can then recover the data. The invention further relates to devices for implementing the foregoing methods.

The invention relates to the secure deposition of data by a depositor on a possibly non-secure storage support and the subsequent recovery of such data by an addressee possibly unknown to the depositor, or non-existing at the time of the deposition. Data are digital data or digitalised analog data.

Known solutions to this problem consist in using a third party.

A first solution, also known as a complete delegation, consists, for a depositor, in encrypting the data with a key of a third party and in transmitting the encrypted data to the third party. In order to subsequently recover the data, the addressee authenticates himself/herself to the third party which transmits him/her back the data he/she previously decrypted with his/her key, then possibly encrypted with a key supplied by the addressee.

A second solution, also known as a right delegation, consists, for the depositor, on the one hand, in encrypting the data with a transfer key, and storing the encrypted data on a storage support accessible to the addressee and, on the other hand, in encrypting the transfer key with the key of the third party and in transmitting the encrypted transfer key to the third party. In order to recover the data subsequently, the addressee authenticates himself/herself to the third party, which transmits back the transfer key he/she previously decrypted with his/her key, then possibly encrypted with a key provided by the addressee. The addressee will then be able to recover the encrypted data on the storage support, then to decrypt the data with the transfer key he/she obtained from the third party.

The encryption of the data and/or of the transfer key can be carried out using either a symmetric encryption method or an asymmetric encryption method.

The known solutions described hereabove have several disadvantages.

A communication channel is required between the depositor and the third party, in order to transmit the data and at least a transfer key.

As the depositor transmits information (data or transfer key) to the third party, the depositor's anonymity is not guaranteed.

The third party must keep the information, data, or at least a transfer key for an unknown, and possibly unlimited time duration, if the addressee does not recover the data. This is not very realistic if a great number of depositors exist and/or big volumes of data are to be kept.

Eventually, in the case of a complete delegation, the third party has a plain access to the data to be transmitted.

The object of the invention is a method for the secure deposition of data and a method for recovering the data, which have none of the above-mentioned disadvantages of the known methods. Another object of the invention consists of devices for the implementation of the methods of the invention.

More precisely, the object of the invention is a method for the secure deposition of data, according to which a depositor encrypts the data with a transfer key and encrypts the transfer key with a key of a third party, then deposits the encrypted data and the encrypted transfer key on a storage support.

The invention also relates to a method for recovering data, according to which:
an addressee recovers from a storage support encrypted data with a transfer key and an encrypted transfer key with the key of a third party,
the addressee authenticates himself/herself to the third party,
the addressee transmits the encrypted transfer key to the third party,
after having authenticated the addressee, the third party decrypts the encrypted transfer key with his or her key and returns the transfer key to the addressee,
the addressee decrypts the encrypted data with the transfer key.

The invention also relates to a secure deposition of data including:
a random number generator for generating a random transfer key (RAND),
first computation means for encrypting the data (DATA) with the transfer key,
second computation means for encrypting the transfer key with the key of a third party, and
means for storing the encrypted data and the encrypted transfer key on a storage support accessible to the addressee of the data.

Thus, and as will be best seen in the example described hereinunder, during the deposition of the data according to the secure method of the invention, the depositor has no contact with the third party, and does not transmit him/her any information, not even a key. Consequently, no communication channel is required between the depositor and the third party and the anonymity of the depositor is guaranteed to the third party. Besides, the third party has no data to store, nor any information on the data. He/she may not even know that an addressee may contact him/her some day. Eventually, the third party has no plain access to the data, unless he/she has a physical access to the data storage support.

The invention will be better understood and other characteristics and advantages of the invention will clearly appear from the description which follows hereinunder and to be used as an indication and not a limitation. The description should be read while referring to the following Figures:

FIG. 1 is a flowchart of a secure deposition method according to the invention,

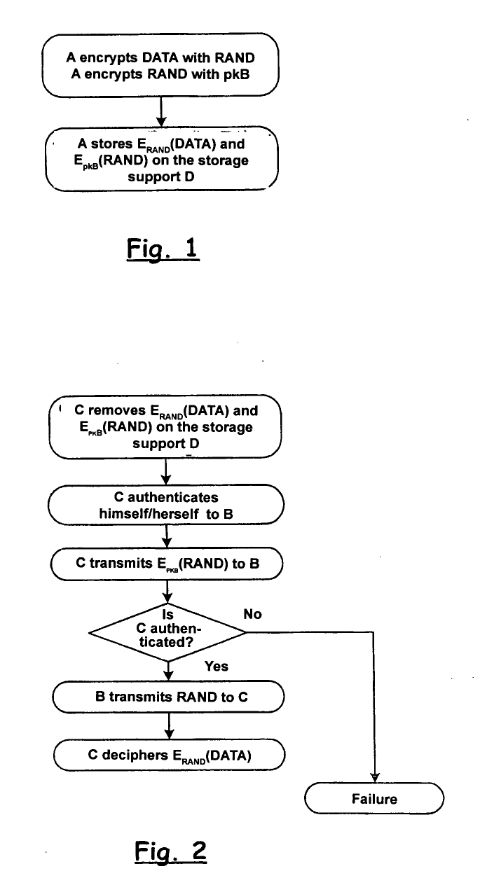

FIG. 2 is a flowchart of a method for recovering data according to the invention and,

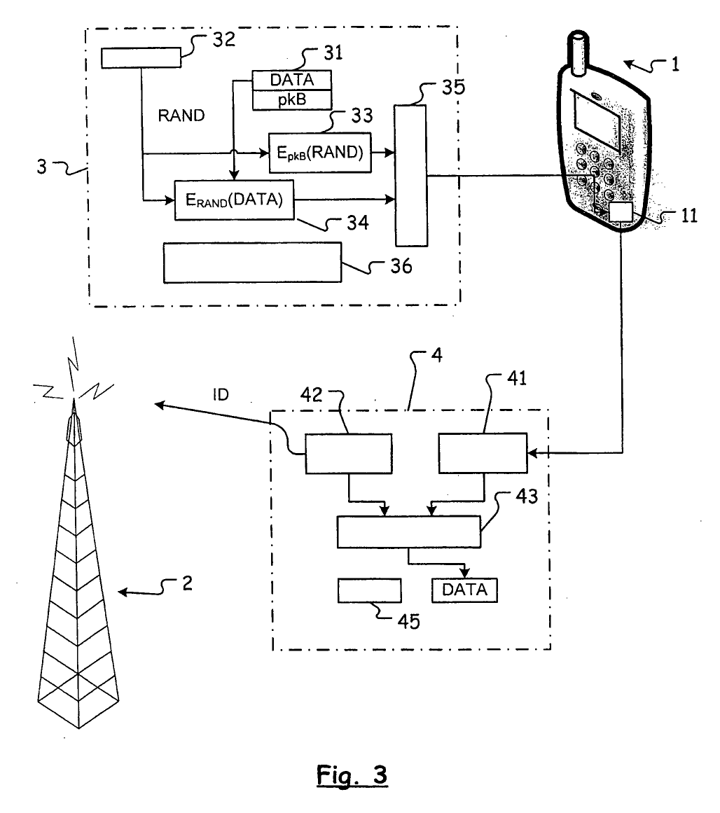

FIG. 3 is an example of a system implementing the deposition method according to claim 1 and the recovering method according to claim 2.

FIG. 3 shows a system likely to be used for implementing the method according to the invention, in the field of mobile communication.

More precisely, the system of FIG. 3 allows a first user having a mobile equipment 1 having an access to the communication network 2 and a personal authentication module 3 to authorize a second user (or even the first user) to use the mobile equipment 1 with a second authentication module 4 to have access to the communication network 2. For this purpose, upon the first user's request, the first authentication module deposits, in a secure way, in a memory of the mobile equipment, data required for having access to the network 2. The system thus enables the secure transfer of data from the first module to the second module through the memory of the mobile equipment.

According to the communication network which the users have access to, the mobile equipment is a mobile telephone, a terminal, a personal PC, etc., and the personal authentication module is a UICC card (Universal Integrated Circuit Card) provided with a SIM application (Subscriber Identity Module), a USIM application (Universal Subscriber Module) or a ISIM application (IP Multimedia Services Identity Module).

FIG. 1 shows a general flowchart of the method for depositing according to the invention. In a first step, a depositor A encrypts the data DATA with a transfer key RAND and encrypts the transfer key RAND with a public key pkB of a third party B. In a second step, A stores the encrypted data E_{RAND} (DATA) and the encrypted transfer key E_{pkB} (RAND) on a storage support.

In the example represented in FIG. 3, the depositor A is a first user's authentication module 3. The third party B is an operator operating a mobile communication network 2. The word “operating” must be understood in its broadest sense. The operator can be a legal person owning the network or renting the network or even a legal person, which sub-contracts the operation of the network to another person. The storage support D is a memory 11 of the portable equipment 1. During the implementation of the method, the module 3 is, of course, connected to the mobile equipment 1.

The first authentication module 3 more particularly includes a memory 31, a random number generator 32, first computation means 33, second computation means 34, storage means 35 and a control device 36.

The memory 31 stores data DATA which, in the example, are data required for identifying the mobile equipment 1 on the communication network 2 and a public key pkB of the communication operator 2.

The random number generator 32 supplies, upon a request from the control device, a random transfer key RAND to the first computation means 33.

The first computation means 33 is adapted for implementing an asymmetric encryption method, such as an RSA (Rivest Shamir Adelman) method or a method based on computations on elliptic curves. It is used for encrypting the key RAND with the public key pkB.

The second computation means 34 is adapted to implement a symmetric encryption method, such as an DES (Data Encryption Standard) method or an AES (Advanced Encryption Standard) method. It is used for encrypting the data DATA with the key RAND which is received from the random numbers generator.

The storage means 35 is adapted for storing, in the memory 11 of the portable equipment 1, the encrypted transfer key E_{pkB}(RAND) and the encrypted data E_{RAND}(DATA).

The control device 36 is adapted for driving the operation of the memory 31, the random numbers generator 32, the first computation means 33, the second computation means 34 and the storage means 35. The control device is for example, activated by the user of the first authentication module.

In practice, in the example of FIG. 3, the first authentication module implements the deposition method according to FIG. 1, as follows.

In a first step, the control device 36 of the first module 3:
activates the random number generator 32 for supplying a transfer key RAND
activates the first computation means 33 which encrypts the transfer key with the public key pkB
activates the second computation means 34 which encrypts the data (DATA) contained in the memory 31 with the transfer key RAND, then
activates the storage means 35 which stores the encrypted key E_{RAND}(RAND) and the encrypted data E_{pkB}(RAND) in the memory 11 of the mobile equipment 1.

FIG. 2 shows a general flowchart of the method for recovering data secured according to the invention.

In a first step, the addressee C recovers the encrypted data E_{RAND}(DATA) and the encrypted transfer key E_{pkB}(RAND) and the encrypted transfer key E_{pkB}(RAND) on the storage support D.

In a second step, the addressee C authenticates himself/herself to the third party B.

In a third step, the addressee C transmits to the third party the encrypted transfer key.

In a fourth step and after having authenticated the addressee C, the third party decrypts the encrypted transfer key E_{pkB}(RAND) with its private key and returns the transfer key RAND to the addressee C.

In a sixth step, the addressee C decrypts the encrypted data E_{RAND}(DATA) with the transfer key.

In the example represented in FIG. 3, the third party B is the mobile communication operator 2, the addressee C is a second user's authentication module 4 and the stored support D is the memory 11 of the portable mobile 1, which the second module is connected in.

The second authentication module 4 more particularly includes reading means 41, communication means 42, third computation means 43, a memory 44 and a control device 45.

The reading means 41 is adapted for reading in the memory 11 the encrypted data and the encrypted transfer key.

The communication means 42 is adapted for exchanging information and/or data with the operator 2 of the mobile communication, and more particularly for:
transmitting to the operator personal authentication data,
transmitting to the operator the encrypted transfer key,
receiving from the operator the decrypted transfer key.

The third computation means 43 is adapted for decrypting the encrypted data E_{RAND}(DATA) using the transfer key supplied by the operator. The data DATA can then be, for example, stored in a memory 44 of the second module 4.

The control device 45 is adapted for driving the operation of the reading means 41, the communication means 42, the third computation means 43 and the memory 44. The control device 45 is, for example, activated by the owner of the first authentication module.

In practice, in the example of FIG. 3, the method for recovering data according to FIG. 1, is implemented as follows. The second authentication module 4 is connected to the mobile equipment 1 for the implementation of the method.

In the first step, the control device 45 activates the reading means 41, which reads the encrypted data and the encrypted transfer key in the memory 11.

In the second step, the control device 45 activates the communication means 42, which transmits to the operator 2 authentication information of the second module 4.

In the third step, the control device 45 activates the communication means 42, which transmits to the operator 2 the encrypted transfer key.

In the fourth step, the operator 2 authenticates the second module 4.

In the fifth step, if the identity of the second module is correct, the operator decrypts the transfer key with his or her personal private key and returns the transfer key to the second module.

In the sixth step, the control device 45 activates the third computation mean, which decrypts the encrypted data E_{RAND} (DATA) with the transfer key.

Many alternative solutions can be used in the above-mentioned example.

In the example, the third party is the mobile communication operator. This could be any other person in the broadest sense: a physical person or a legal person, but also a data server, etc. It is sufficient that said physical person or a legal person has a set of keys including a public key pkB and an associated private key, and some hardware to use it, of course.

In the example still, the public key pkB of the third party is stored in the memory 31 of the first module 3. Said key could also be stored in the memory 11 of the mobile equipment. It also could be requested by the module 3, from the third party, for example, or from any other person having such key, just prior to be used for encrypting the key RAND.

Still in the example, a symmetric encryption method is used for encrypting the data. An asymmetric encryption method could also be used, but its implementation would be slower and entail higher costs than the implementation of a symmetric method.

In the example described, an asymmetric encryption method is used for encrypting the transfer key RAND. This avoids the depositor and the addressee to make a prior agreement on a transfer key to be used. Besides, since the encryption by the transfer key only is used in the authentication modules, a non-secured implementation of such encryption method is sufficient and not very expensive, and can be easily executed on a chip card. The associated decryption method, which is much more expensive, is implemented by the third party, which owns much more important hardware, such as a server.

In the example of FIG. 3, the addressee C transmits to the third party B information relating to his/her identity that the third party B checks for authenticating or not the addressee C, i.e. for validating or not validating the right of access to the data by the addressee C. It has thus been assumed that the third party B would have sufficient information, in anticipation, for authenticating the addressee C. In the example, the authentication information is indication of subscriptions to the operator's communication network such as a subscription number. Then the depositor A can, in the example, allow any person having an authentication module for the same network to use the mobile equipment, without giving precise information on this person.

In an alternative, during the process of deposition of the data, the depositor A also stores, on the storage support, criteria ID giving access to the data, more particularly including a hashing of the key RAND and the addressee's C authentication information. Such access criteria demonstrate that the key RAND is associated with the data. Such criteria are encrypted with the key pkB and signed by the depositor. During the recovering process, the addressee transmits to the third party the access criteria together with its personal authentication data. The third party will then use such criteria ID and the personal identification data transmitted by the addressee for authenticating him/her.

In the example, eventually, the storage support D is the memory 11 of the mobile equipment 1. Generally speaking, the storage support is somehow a container, i.e. means for storing digital data. The storage support D can, for example, be a removable storage support such as a compact disc CD, a DVD (Digital Versatile Disc), a non volatile memory, a memory module, an SD card (Secured Digital Card) or any other type of memory card. It can be kept by a physical person or a legal person, and/or be stored in a data server.

The example of FIG. 3 shows an application of the invention in the field of mobile communication. Many other applications can be considered. More precisely, any application in which a depositor wishes to transmit, in a totally secure way, data to an addressee, possibly a non-identified one upon depositing data, and while limiting the constraints imposed to the third party, which is active only at the moment of recovering the data.

The invention can, for example, be used for transmitting information within a dynamic group, the members of which come in and go out at any time, the members not necessarily knowing each other. For example, the method according to the invention can be used for allowing different participants (persons, companies), on a given site (for example, a factory), to leave information (for example, connected to the operation of the site or to the action which was carried out on the site), to one or several subsequent operator or operators, the various operators not necessarily knowing each other. The third party can for example, be the owner, the manager of the site or any other person having to coordinate the action of various operators on the site, without having an interest in knowing, or needing to know the information exchanged between the operators.

The invention can also be advantageously used for any application in which the depositor wishes to transmit information, while keeping a complete anonymity, or in which the addressee is anonymous for the depositor.

It should be noted that the existence of the addressee is not necessary at the moment the data are deposited. Similarly, the existence of the depositor is no longer necessary upon recovering the data.

1. A method for the secure deposition of data, according to which a depositor encrypts the data with a transfer key and encrypts the transfer key with a key of a third party, then deposits the encrypted data and the encrypted transfer key on a storage support.

2. A method according to claim 1, according to which the depositor also encrypts authentication criteria of an addressee of the encrypted data with the key of the third party, then stores the encrypted authentication criteria on the storage support.

3. A method according to claim 1, according to which the depositor generates the transfer key in a random way, prior to encrypting the data with the transfer key.

4. A method according to claim 1, according to which the depositor encrypts the data using a symmetric encryption method or an asymmetric encryption method.

5. A method according to claim 1, according to which the depositor encrypts the transfer key using an asymmetric encryption method or a symmetric encryption method.

6. A method according to claim 1, wherein the depositor and/or the third party are:
one or several physical or legal person or persons, or
one or several subscriber's authentication module or modules, or
a terminal or terminals.

7. A method according to claim 6, wherein the depositor is an authentication module of a subscriber to a mobile communication network, and wherein the third party is an operator operating said communication network.

8. A method according to claim 1, wherein the storage support is:
a memory of a terminal, comprising one of a portable telephone, a personal computer or a server, or
a removable storage support comprising one of a compact disk, a DVD, or a memory card.

9. A method for recovering data, according to which:
an addressee recovers from a storage support data encrypted with a transfer key, and a transfer key encrypted with the key of a third party,
the addressee authenticates himself/herself to the third party,
the addressee sends the encrypted transfer key to the third party,
after having authenticated the addressee, the third party decrypts the encrypted transfer key using his/her key and returns the transfer key to the addressee,
the addressee decrypts the encrypted data using the transfer key.

10. A method according to claim 9, wherein the third party and/or the addressee are:
one or several person or persons, or
one or several subscriber's authentication module or modules, or
a terminal or terminals.

11. A method according to claim 9, according to which the addressee decrypts the data using a symmetric decryption method or an asymmetric decryption method.

12. A method according to claim 9, according to which the third party decrypts the transfer key using an asymmetric decryption method or a symmetric decryption method.

13. A device for the secure deposition of data, comprising:
a random number generator for generating a random transfer key,
first computation means for encrypting data with the transfer key,
second computation means for encrypting the transfer key using the key of a third party, and
means for storing the encrypted data and the encrypted transfer key on a storage support accessible to an addressee of the data.

14. A device according to claim 13, wherein the second computation means is also appropriate for encrypting the addressee's authentication criteria with the key of a third party, the device also including means for storing the encrypted authentication data on the storage support.

15. A device according to claim 13, wherein said device comprises an authentication module of a subscriber to a communication network.

16. A device for recovering data comprising:
reading means for reading encrypted data and an encrypted transfer key on a storage support,
communication means for transmitting to a third party personal authentication data and the encrypted transfer key, and for receiving from said third party the decrypted transfer key,
computation means for decrypting the encrypted data with the transfer key received from the third party.

17. A device according to claim 16, wherein said device comprises a subscriber's authentication module.
